(19) United States
(12) Patent Application Publication
(10) Pub. No.: US 2010/0275876 A1
(43) Pub. Date: Nov. 4, 2010

(54) Extreme efficiency rotary engine

(75) Inventor: Robert Jackson Reid, Santa Rosa, CA (US)

Correspondence Address: Robert J. Reid, 5249 Winter Creek Rd., Santa Rosa, CA, 95404, US

(73) Assignee: Engines Unlimited, Inc.

(21) Appl. No.: 12/387,635

(22) Filed: May 4, 2009

(51) Int. Cl. F02B 53/00; B23K 3/00

(52) U.S. Cl. 123/200; 29/888.012

(57) ABSTRACT

This rotary engine configuration combines the four cycles required to produce power, thrust, exhaust, intake, and compression which are merged into a single cycle per revolution. Most conventional engine designs need two revolutions. This requires the mechanical functions to produce power simultaneously; consequently, the parts are performing several functions at the same time. So, only very few parts are needed. The rotor is the big worker. Combustion turns the rotor power cog one way, while the exhaust gases go the opposite way to escape through an opening directly behind the power cog, into the open air. In this concept, where many power generating functions are going on at the same time, only one moving assembly is needed. Fewer parts used translate into the many benefits described in the claims. The fact that 345 degrees pressure differential are being applied to the power cog is doing work. This work produced during the 345 degrees maximizes more fuel economy compared to conventional engines.

### CROSS-REFERENCE TO RELATED APPLICATIONS

This application claims the benefit of patent application Ser. No. 12/002,238, filed Dec. 13, 2007, entitled “Extreme Efficiency Rotary Engine” by the present inventor.

### FEDERALLY SPONSORED RESEARCH

Non-applicable

### SEQUENCE LISTING OR PROGRAM

Non-applicable

### BACKGROUND OF THE INVENTION

1. Field of the Invention

This invention pertains to improvements to the Extreme Efficiency Rotary Engine, reference: patent application Ser. No. 12/002,238, filed Dec. 13, 2007.

2. Prior Art

I found no prior art, technical write-ups, or news releases pertaining to this unique rotary engine configuration, nor have I had any discussions with anyone concerning this design.

3. Objects and Advantages

The objects and advantages over prior rotary engine art and over the “Extreme Efficiency Rotary Engine” patent application Ser. No. 12/002,238, filed Dec. 13, 2007, together with said patent's original advantages that remain effective are listed below.

Original Invention Features Retained:

(a) this design has almost no friction so it can coast farther;

(b) this design does not need a cooling system

(c) this design does not use “crank-case” oil;

(d) this engine will not be damaged by airborne ashes, sand, dirt, or other small particles;

(e) this engine will not need an exhaust pipe or muffler or anti-smog converter;

Improved Invention Features

(a) improved engine efficiency by means of a higher pressure, adjustable super charger.

(b) the number of engine moving parts has been reduced to one rotating assembly.

(c) the reduction of moving parts further reduces engine size, weight, cost to produce, and lowers costs to repair.

(d) operating reliability is improved.

Original Invention Features Removed:

(a) the combustion gases exhaust fan is not used because power calculations indicate that an exhaust fan does not improve efficiency enough to be cost effective.

(b) the “momentum rings” have been removed because the contribution to the system is offset by the extra weight, cost, and extra engine power needed to use it.

(c) the combustor has been removed; combustion now takes place in front of the power cog within the exhaust channel.

### SUMMARY

This “improved Extreme Efficiency Rotary Engine” design retains many valuable features of the original patent design while adding significant improvements. Two features of the original design have been removed. The improvements when added will increase the overall benefits to society substantially of this new configuration rotary engine. Specifically, the benefits of greatly reduced oil usage and the corresponding reduced emission of carbon dioxide into our air will be of immense value to society.

### DRAWINGS—FIGURES

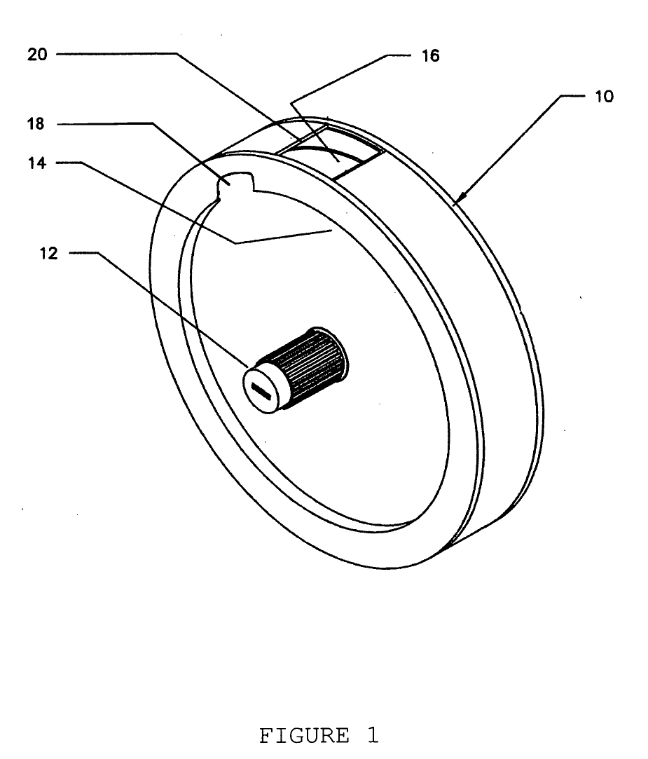

### Description—FIGS. 1, 2 and 3.

In the drawings:

FIG. 1 provides details of the “Rotating Assembly”.

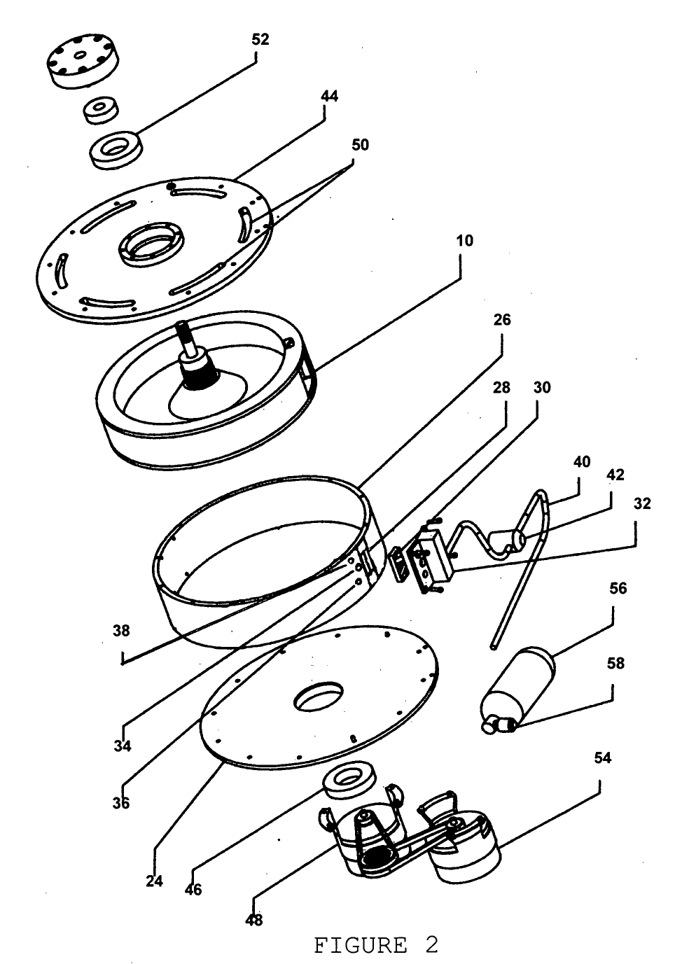

FIG. 2 provides a detailed description of the complete engine.

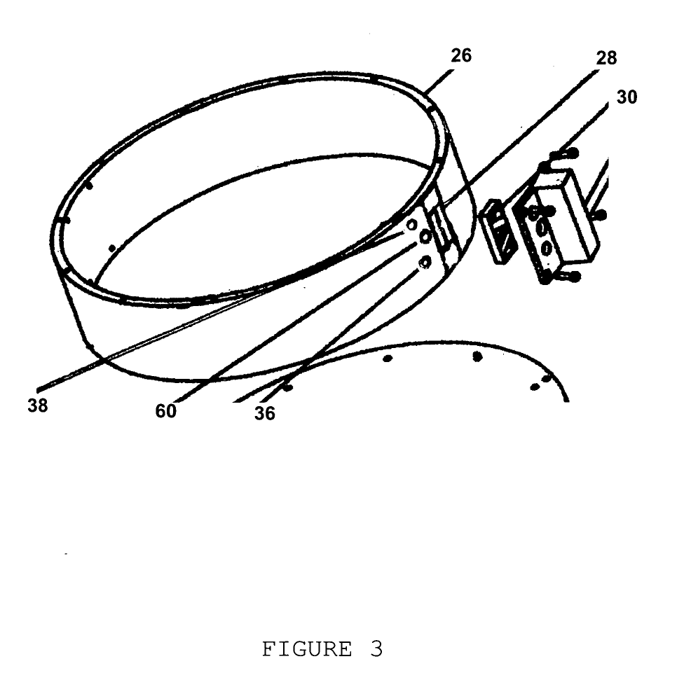

FIG. 3 provides configuration changes that will enable the burning of natural gas.

### DRAWINGS—REFERENCE NUMERALS

One page of reference numerals with part names is provided.

### REFERENCE NUMERALS

| | |
|---|---|
| 10 | Rotating Assembly |
| 12 | Shaft |
| 14 | Exhaust Channel |
| 16 | Air Opening No. 2 |
| 18 | Exhaust Outlet |
| 20 | Power Cog |
| 24 | Front Structural Plate |
| 26 | Outer Band |
| 28 | Air Opening No. 1 |
| 30 | Convolver |
| 32 | Air Inlet Cover |
| 34 | Fuel Injector Mounting |
| 36 | Spark Plug No. 1 Mounting |
| 38 | Spark Plug No. 2 Mounting |
| 40 | Compressed Air Conduit |
| 42 | Adjustable Pressure Regulator |
| 44 | Rear Structural Plate |
| 46 | Front Bearing |
| 48 | Air Compressor |
| 50 | Exhaust Exit Ports |
| 52 | Rear Bearing |
| 54 | Starter |
| 56 | Air Tank |
| 58 | Safety Valve |
| 60 | High Pressure Natural |
| | Gas Conduit |

### DETAILED DESCRIPTION—PREFERRED EMBODIMENT

The engine has two parts. The rotating assembly will be described first and is shown in FIG. 1. This is the only part that actually moves in the whole engine.

To produce power the rotating assembly sections integrate with non-moving parts located in the rest of the engine, as shown in FIG. 2.

FIG. 3 describes configuration changes that will enable the burning of natural gas.

FIGS. 1 through 3 and the parts list with reference numerals show explicit configuration details of the preferred model.

### Operations—FIGS. 1, 2, and 3

The “rotating assembly” reference numeral 10 contains a “shaft,” reference numeral 12, an “exhaust channel,” reference numeral 14, a “power cog,” reference numeral 20, an “exhaust gas outlet,” reference numeral 18, and “air opening No. 2,” reference numeral 16. The “exhaust channel” reference numeral 14 extends almost 360 degrees around the “rotating assembly” reference numeral 10 and emerges at the “exhaust gas outlet” reference numeral 18 which is a large opening in the side of the “exhaust channel” reference numeral 14. The “exhaust gas outlet” reference numeral 18 is located just behind the “power cog” reference numeral 20. From this point, the exhaust gas leaves the rotor and exits the engine through the “exhaust exit port” reference numeral 50.

The last item in the “rotating assembly” reference numeral 10 is “air opening No. 2” reference numeral 16. “air opening No. 2” reference numeral 16 rotates but the matching “air opening No. 1” reference numeral 28 does not. The leading edge of “air opening No. 2” reference numeral 16 must coincide with the flat face of the “power cog” reference numeral 20 so that compressed air can start building up immediately.

The “rotating assembly” reference numeral 10 is included in FIG. 2. The “exhaust exit ports” reference numeral 50, allow the exhaust gases to exit the engine. “Air opening No. 1” reference numeral 28 is a structural part for holding the two structural plate's reference numerals 24, the “front structural plate” and 44, the “rear structural plate. The “convolver” reference numeral 30, improves combustion by mixing incoming air which enters as a jet through the “compressed air conduit” reference numeral 40 and integrates, stirs and changes, making a more combustible mix. The “convolver” reference numeral 40 inserts into the outer band and is held in place under the “air inlet cover” reference numeral 32.

In FIG. 3, it is required that the “fuel injector” reference numeral 34 be removed with the insertion of a “high pressure natural gas conduit,” reference numeral 60 using the same mounting location for conversion to natural gas.

### Description of Item Functions and Inter-Relationships

The “power cog,” reference numeral 20, which has a flat face on the power generating side, generates force when pressure is applied. The larger the cog's surface area, the more force is generated. The distance between the center of the surface area and the center of the shaft determines the length of the torque arm.

The “power cog” reference numeral 20 closes off the “exhaust channel” reference numeral 14 which is an enclosed tunnel that goes around the “rotating assembly” reference numeral 10 to the rear of the “power cog” reference numeral 20 where it exits through the side of the “exhaust channel” reference numeral 14 into a space inside the engine. The exhaust gases then exit through the “exhaust exit ports” reference numeral 50.

Whenever “air opening No. 1” reference numeral 28 in the outer band matches “air opening No. 2” reference numeral 16, compressed air is able to enter the “exhaust channel” reference numeral 14 directly in front of the “power cog” reference numeral 20. “Air opening No. 1” reference numeral 28 then allows mountings for the “fuel injector” reference numeral 34 and the “two spark plugs” reference numerals 36 and 38 in the proper sequence. To burn natural gas, propane, or liquefied natural gas, simply remove the “fuel injector” reference numeral 34 and connect the “high pressure natural gas conduit” reference numeral 60 to that same opening at the appropriate pressure.

To minimize pressure losses around “air opening No. 1” reference numeral 38, a tolerance of about 0.004 inches is designed in between the “outer band” reference numeral 26 and the “exhaust channel” reference numeral 14.

The “convolver” reference numeral 30, which makes the pool of incoming compressed air more uniform, fits into “air opening No. 1” reference numeral 28 underneath the “air inlet cover” reference numeral 32.

An “adjustable pressure regulator” is reference numeral 40. When higher pressure is available, more power is available from the engine. An adjustment to the compression is equivalent to using a supercharger on a car engine with the exception that adjustable super chargers are not available. This feature will facilitate operating the engine at a desired revolutions-per-minute setting.

### Procedure to Design Different Sized Engines

The following procedure can be used to calculate horsepower of my engine. The calculation uses a series of stages and computes the horsepower at each stage.

### Stage 1

Length of travel inside the “exhaust channel” reference numeral 14 is called stage travel. The length of travel in stage 1 is the length of the exhaust channel used. This creates one rpm which is multiplied by the “power cog” refer area. This result is then multiplied by the pressure; times the torque arm length. This then yields the work done in inch pounds for one revolution, which in turn translates into horsepower.

### Stage 2

In stage 2 and remaining stages, the exhaust channel travel is double the preceding stage travel; times an air viscosity factor. Air viscosity versus temperature data can be found in the Handbook of Chemistry and Physics. In stage 2, multiply stage 1 travel by 2 times the viscosity ratio; times power cog area; times ½ (one-half) the preceding pressure; times the torque arm length. This calculation then yields a second amount of work done. Continue calculating work done during each stage until the stage travel distance equals the total length of the “exhaust channel.” The result may not come out exactly even; an adjustment to the work done may be needed.

To obtain horsepower per revolution, add the inch pounds of work done in all applicable stages. Divide this total by 396000 to get horsepower generated per revolution.

### Advantages

A major advantage of my engine is due to the fact that it has very little friction. By contrast, about 12 percent of conventional engine's output power is lost due to internal friction.

Another major advantage is that air pressure used for combustion can be controlled by the driver. This is comparable to having a controllable supercharger, but controllable superchargers are not made.

### Scope

The preferred model, just described has many more applications than in the automotive industry. These applications will need only dimensional adaptations to provide efficient power to vehicles on land such as: trucks, buses, RV's, military vehicles, construction equipment, stationary pumps, and farm equipment, etc.

On the sea this engine would be highly desirable because it would be immune to sea water corrosion. In the air this engine, because of its lighter weight, fuel economy and better reliability would provide better power for propeller installed aircraft.

### Positive and Negative Factors Evaluation

Inventor(s): Robert J. Reid Invention: Improved Extreme Efficiency Rotary Engine

| Factor | Score (−100 to +100) |
|---|---|
| 1. Cost | (+50) |
| 2. Weight | (+50) |
| 3. Size | (+50) |
| 4. Safety/Health | (+20) |
| 5. Ease of Use | (+30) |
| 6. Ease of Production | (+40) |
| 7. Durability | (+80) |
| 8. Repairability | (+80) |
| 9. Social Benefit | (+100) |
| 10. Reliability | (+80) |
| 11. Ecology | (+100) |
| 12. Saleability | (+80) |
| 13. Noise | (+20) |
| 14. Market Size | (+80) |
| 15. Trend of Demand | (+80) |
| 16. Difficulty of Market Penetration | (+80) |
| 17. Potential Competition | (+80) |
| 18. Quality | (+20) |
| 19. Markup | (+70) |
| 20. Miscellaneous | (−30) |
| 21. Long Life Cycle | (+80) |
| 22. Satisfies Existing Need | (+100) |
| 23. Operability | (−10) |
| 24. Development | (−80) |
| 25. Profitability | (+80) |
| 26. Obsolescence | (+50) |
| 27. Incompatibility | (−30) |
| 28. Service Requirements | (+80) |
| 29. New Tooling Required | (−40) |
| 30. Substantial Learning Required | (−40) |
| 31. Combination Products | (+50) |
| 32. Prototype Availability | (−40) |
| 33. Broad Pat. Coverage Available | (+70) |
| 34. High Sales Anticipated | (+70) |

OVERALL NET TOTAL: +1500

### Conclusion

One must conclude that the societal value of reduced crude oil consumption, reduced greenhouse gas emissions, elimination of smog, and the reduction in costs of equipment powered by this extremely efficient rotary engine are the “heavyweights.” The worth of these social benefits ultimately is beyond calculation. The world needs this invention!

I claim:

1. A single cycle rotary engine for powering—but not limited to—automobiles, where said rotary engine which comprises the following housing components, wherein said components being defined by a “Starter/Generator” and a “Air Compressor” mounted on the front of a “Front Structural Plate”, whereupon the reverse side of said “Front Structural Plate” is mounted the “Outer Band”, to which is mounted on the outside wall “Air Opening No. 1” with the “Convolver” inserted in this opening, followed by the “Air Inlet Cover”, to which is attached the “Compressed Air Conduit” in whose member is inserted the “Adjustable Pressure Regulator”; on the inside of said “Outer Band” lies the “Rotating Assembly” to which is mounted “Air Opening No. 2”, below which lies the “Exhaust Channel” to which and behind said “Power Cog” is mounted the “Exhaust Gas Outlet”, adjacent to which is the “Bottom Structural Plate” of said engine that will, when properly constructed provide energy savings, lower carbon dioxide emission, minimal pollution emission, and lower consumer costs as compared with typical piston engines.

2. The rotary engine recited in claim 1 wherein substantial fuel savings is accomplished by incorporating a new power generating cycle by combining the power stroke with the exhaust stroke and the compression stroke and ignition, thereby greatly increasing the efficiency of said engine.

3. The rotary engine recited in claim 1 wherein said engine uses low working temperatures which are far below 2800 degrees to prevent forming pollution or smog from the formation of nitrogen oxide (NOₓ).

4. The rotary engine recited in claim 1 wherein lower consumer costs to operate said engine are the direct result of said engine's condensed configuration including: no cooling system, no crankcase oil, no muffler or smog converter or hot exhaust air.

5. The rotary engine recited in claim 1 wherein additional fuel savings by said engine comprising low friction configuration advantages in that: said engine uses almost no energy-absorbing friction which allows it to coast farther on the highway; in addition, said engine will use very little fuel while the vehicle is stopped or coasting slowly, therefore said engine will use less fuel over time, thereby improving said engine's value to society.

6. The rotary engine recited in claim 1 wherein said engine provides immense social benefit by reducing the need for crude oil by approximately two-thirds of the oil used presently which will markedly reduce owner's costs to own and operate said engine.

7. The rotary engine recited in claim 1 whereby in a military application, said engine would allow for more ammunition or fuel to be carried per trip, thus bringing down logistic support costs.

8. The rotary engine recited in claim 1 wherein said engine may be manufactured such as to produce a very large engine, one that will provide one megawatt electricity or more might be utilized continually in critical areas such as civil defense areas, state capitols, and Washington D.C. which might be used in the event that a primary electrical grid should become damaged; said large megawatt engines with three complete power sources including three rotary engine attached to three turbine may be placed into operation to fill the gap until such damage to the grid is repaired and may be installed on a mobile flatbed trailer which might bring power to a “troubled area” quickly thus protecting critical areas from the threat that hackers or foreign agents might disable large national power grids.

9. A single cycle rotary engine for powering—but not limited to—automobiles, where said rotary engine which comprises the following housing components, wherein said components being defined by a “Starter/Generator” and a “Air Compressor” mounted on the front of a “Front Structural Plate”, whereupon the reverse side of said “Front Structural Plate” is mounted the “Outer Band”, to which is mounted on the outside wall “Air Opening No. 1” with the “Convolver” inserted in this opening, followed by the “Air Inlet Cover”, to which is attached the “Compressed Air Conduit” in whose member is inserted the “Adjustable Pressure Regulator” ; on the inside of said “Outer Band” lies the “Rotating Assembly” to which is mounted “Air Opening No. 2”, below which lies the “Exhaust Channel” to which and behind said “Power Cog” is mounted the “Exhaust Gas Outlet”, adjacent to which is the “Bottom Structural Plate” of said engine that will, when properly constructed provide valuable design features.

10. The rotary engine recited in claim 9 wherein said engine's configuration has valuable features which comprise the facility of said engine parts to be manufactured through current and available tooling which will expedite production of said engine, thus making it easier and cheaper to mass produce, due to the fact that said rotary engine requires only 18 parts, far less than the 100 plus parts needed to build a conventional engine and also much less money is needed to provide storage for these parts over time thereby improving said engine's value to society and individual owners.

11. The rotary engine recited in claim 9 wherein said engine has valuable physical dimensions comprising said engine's installation requirement for less volume thereby either allowing for a more compact vehicle or releasing space within the vehicle for other uses such as operating a generator which can provide 110 volt electricity to individual houses, and said engine's inherent property of weighing less than a typical piston engine each results in more mileage per gallon of fuel used, thereby improving said engine's value to society.

12. The rotary engine recited in claim 9 wherein high reliability is made possible because said engine uses very few moving that can wear out.

13. The rotary engine recited in claim 9 wherein are additional valuable features of said engine which comprises the need for a lesser number and lower cost repairs given that said engine uses a very small number of extremely reliable parts, hence said engine is expected to last for hundreds of thousands of miles, thereby improving said engine's value to society.

14. The rotary engine recited in claim 9 wherein said engine has a reduced size and weight which translates to a reduction in the costs to produce as compared to conventional piston-type engines today.

15. The rotary engine recited in claim 9 wherein unique features of said engine comprising the fact that said engine will not be damaged by airborne ashes, sand, dirt or other small particles because operating clearances are large enough to accommodate small particles without damage to said engine together with the fact that said engine will make almost no noise and said engine will waste little to no exhaust heat energy and will start no fires because exhaust gases are cooled by expansion thereby improving said engine's value to society.

16. The rotary engine recited in claim 9 wherein said engine's configuration has valuable features which comprise, especially pertinent to generating AC power, wherein the “adjustable pressure regulator” allows the means to control the rotation of the engine precisely at a particular frequency together with said engine's variable compression pressures, this can produce more or less power.

17. A single cycle rotary engine for powering—but not limited to—automobiles, which comprises a “Starter/Generator” and a “Air Compressor” mounted on the front of a “Front Structural Plate”, whereupon the reverse side of said “Front Structural Plate” is mounted the “Outer Band”, to which is mounted on the outside wall “Air Opening No. 1” with the “Convolver” inserted in this opening, followed by the “Air Inlet Cover”, to which is attached the “Compressed Air Conduit” in whose member is inserted the “Adjustable Pressure Regulator”; on the inside of said “Outer Band” lies the “Rotating Assembly” to which is mounted “Air Opening No. 2”, below which lies the “Exhaust Channel” to which and behind said “Power Cog” is mounted the “Exhaust Gas Outlet”, adjacent to which is the “Rear Structural Plate”; the power is conceived wherein pressure, multiplied by the area of said “Power Cog” times the effective length of the “Torque Arm,” generates horsepower which continues to be generated so long as there is a pressure differential between said “Power Cog” and the “Exhaust Outlet” said engine, resulting that pressure is released through said “Exhaust Outlet” as the exhaust gases escape through the opening directly behind said “Power Cog” to provide the energy necessary to propel the vehicle.

18. The rotary engine recited in claim 17 wherein said engine has greatly improved reliability, repairability, and durability compared to all conventional engines of equal horsepower available today.

19. The rotary engine recited in claim 17 wherein said engine is relatively immune from sea water corrosion translates into longer engine life for a sea going vessel.

20. The rotary engine recited in claim 17 wherein said engine, because of its lighter weight, fuel economy and better reliability can thereby provide cheaper passenger miles for propeller installed aircraft.
